(19) United States
(12) Patent Application Publication
(10) Pub. No.: US 2024/0170804 A1
(43) Pub. Date: May 23, 2024

(54) BUS BAR MODULES FOR TRACTION BATTERY PACKS

(71) Applicant: FORD GLOBAL TECHNOLOGIES, LLC, Dearborn, MI (US)

(72) Inventors: Jason C. MARCATH, Dearborn, MI (US); Joseph FRICANO, Canton, MI (US); Karen SILER, Commerce Township, MI (US); Ryan Douglas MATULICH, Farmington, MI (US); Vanessa WOODIWISS, Tecumseh (CA)

(21) Appl. No.: 18/056,419

(22) Filed: Nov. 17, 2022

(51) Int. Cl. H01M 50/507; H01M 50/569

(52) U.S. Cl. CPC H01M 50/507; H01M 50/569

(57) ABSTRACT

Bus bar modules are provided for electrically connecting battery cells of a traction battery pack. An exemplary bus bar module may include a multi-layer assembly that includes a base layer, a mid-layer, and a top layer, with each layer having its own respective function(s). The bus bar module may provide the structure for both retaining bus bars and routing sense lead wiring. The bus bar module may further provide integrated features for venting, facilitating bus bar-to-terminal welding, and testing sense lead connections.

### TECHNICAL FIELD

This disclosure relates generally to traction battery packs, and more particularly to bus bar modules for electrically connecting battery cells of a traction battery pack.

### BACKGROUND

Electrified vehicles include a traction battery pack for powering electric machines and other electrical loads of the vehicle. Traction battery packs include a plurality of battery cells. The battery cells must be reliably connected to one another in order to provide the necessary voltage and power levels necessary for achieving vehicle propulsion.

### SUMMARY

A traction battery pack according to an exemplary aspect of the present disclosure includes, among other things, a grouping of battery cells, and a bus bar module arranged to electrically connect the grouping of battery cells. The bus bar module includes a base layer positioned in contact with the grouping of battery cells, a mid-layer configured to retain a plurality of bus bars along a first axis and a second axis, and a top layer configured to retain the plurality of bus bars along a third axis.

In a further non-limiting embodiment of the forgoing traction battery pack, the first axis is an X-axis, the second axis is a Y-axis, and the third axis is a Z-axis.

In a further non-limiting embodiment of either of the foregoing traction battery packs, the mid-layer is sandwiched between the base layer and the top layer.

In a further non-limiting embodiment of any of the foregoing traction battery packs, the plurality of bus bars are isolated from the grouping of battery cells by the base layer.

In a further non-limiting embodiment of any of the foregoing traction battery packs, the bus bar module includes a welding access point formed in the top layer and located at a position that is received over top of and in direct alignment with a bus bar of the plurality of bus bars.

In a further non-limiting embodiment of any of the foregoing traction battery packs, the welding access point includes a central access port and a plurality of peripheral access ports arranged to circumscribe the central access port.

In a further non-limiting embodiment of any of the foregoing traction battery packs, the central access port is formed through a ring of the top layer. The ring is connected to a main body of the top layer by a plurality of struts.

In a further non-limiting embodiment of any of the foregoing traction battery packs, the bus bar module includes a vent port arranged over top of and in direct alignment with a vent system of a battery cell of the grouping of battery cells.

In a further non-limiting embodiment of any of the foregoing traction battery packs, a first opening of the base layer, a second opening of the mid-layer, and a third opening of the top layer align with one another to establish the vent port.

In a further non-limiting embodiment of any of the foregoing traction battery packs, the third opening is bifurcated by a strut to form a pair of sub-openings in the top layer.

In a further non-limiting embodiment of any of the foregoing traction battery packs, the bus bar module includes a sense lead testing access port formed through the top layer.

In a further non-limiting embodiment of any of the foregoing traction battery packs, a sense lead wire of the bus bar module is arranged in a weaving pattern relative to the mid-layer.

In a further non-limiting embodiment of any of the foregoing traction battery packs, the weaving pattern extends in and out of a wire pocket and over a beam of the mid-layer.

A traction battery pack according to another exemplary aspect of the present disclosure includes, among other things, a grouping of battery cells, and a bus bar module arranged to electrically connect the grouping of battery cells. The bus bar module includes a base layer, a top layer, a mid-layer sandwiched between the base layer and the top layer, and a bus bar movably arranged between the mid-layer and the top layer.

In a further non-limiting embodiment of the foregoing traction battery pack, the top layer includes a welding access point located over the bus bar. The bus bar is located over a terminal of a battery cell of the grouping of battery cells.

In a further non-limiting embodiment of either of the foregoing traction battery packs, the welding access point includes a central access port and a plurality of peripheral access ports arranged to circumscribe the central access port.

In a further non-limiting embodiment of any of the foregoing traction battery packs, the bus bar module includes a vent port arranged over a vent system of a battery cell of the grouping of battery cells.

In a further non-limiting embodiment of any of the foregoing traction battery packs, a first opening of the base layer, a second opening of the mid-layer, and a third opening of the top layer align with one another to establish the vent port.

In a further non-limiting embodiment of any of the foregoing traction battery packs, the bus bar module includes a sense lead wire arranged in a weaving pattern relative to the mid-layer.

In a further non-limiting embodiment of any of the foregoing traction battery packs, the weaving pattern extends in and out of a wire pocket and over a beam of the mid-layer.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates select portions of a traction battery pack.

FIG. 3 is an exploded view of a bus bar module of the traction battery pack of FIG. 2.

FIG. 4 is a blown-up view of select portions of a bus bar module of the traction battery pack of FIG. 2.

FIG. 5 is a cross-sectional view through section 5-5 of FIG. 4.

FIG. 6 is a cross-sectional view through section 6-6 of FIG. 4.

FIG. 7 is a cross-sectional view through section 7-7 of FIG. 4.

FIG. 8 illustrates a routing pattern of sense lead wiring of a bus bar module.

### DETAILED DESCRIPTION

This disclosure details bus bar modules for electrically connecting battery cells of a traction battery pack. An exemplary bus bar module may include a multi-layer assembly that includes a base layer, a mid-layer, and a top layer, with each layer having its own respective function(s). The bus bar module may provide the structure for both retaining bus bars and routing sense lead wiring. The bus bar module may further provide integrated features for venting, facilitating bus bar-to-terminal welding, and testing sense lead connections. These and other features are discussed in greater detail in the following paragraphs of this detailed description.

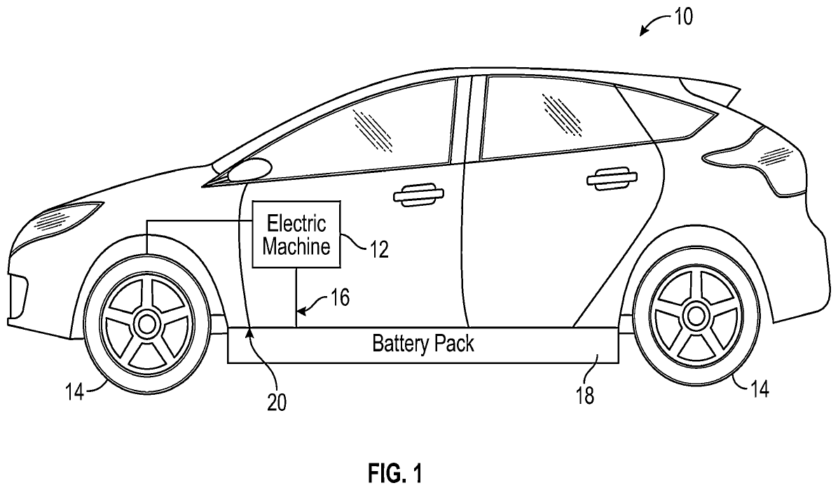

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

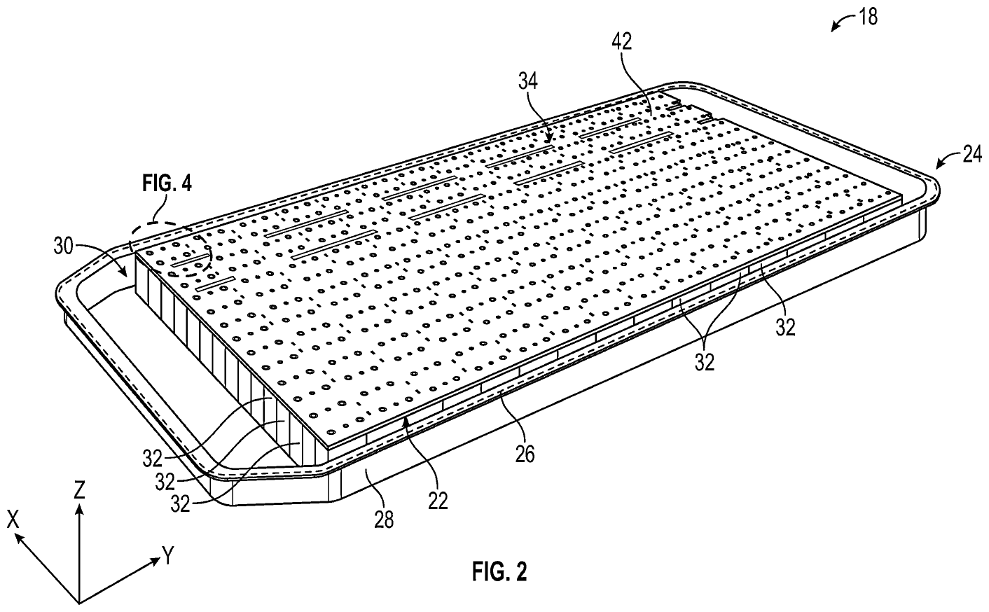

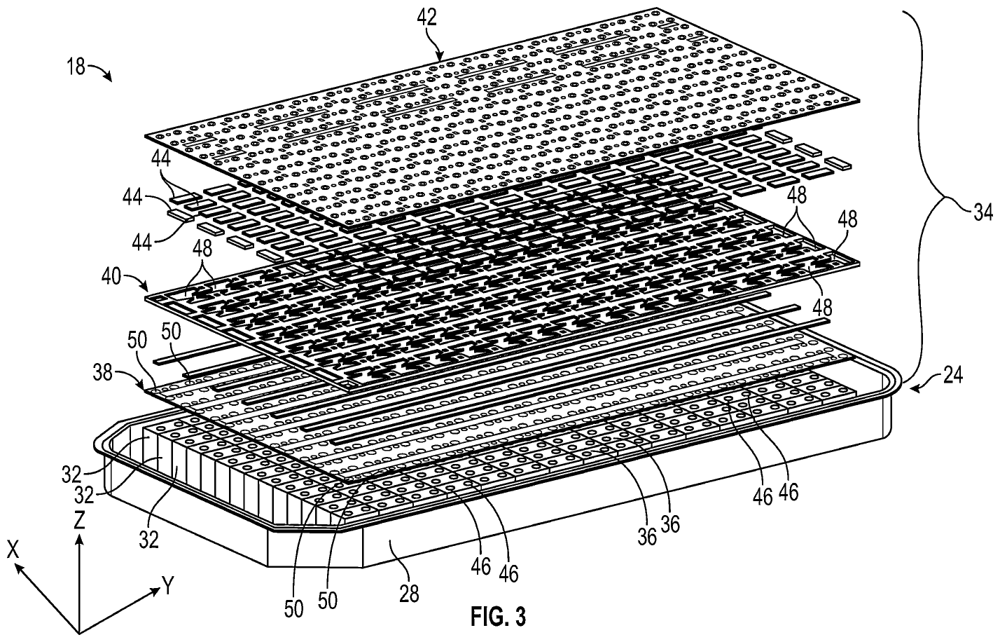

Referring now to FIGS. 2 and 3, the traction battery pack 18 may include a battery system 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the battery system 22.

The battery system 22 may include one or more groupings of battery cells 32 and a bus bar module 34 arranged to electrically connect the battery cells 32. Once electrically coupled, the battery cells 32 may supply electrical power for powering various components of the electrified vehicle 10.

In an embodiment, the battery cells 32 are arranged in a single, large format battery cell grouping, which may be referred to as a cell matrix when the battery system 22 is configured as a cell-to-pack type battery system. However, other configurations are also possible. For example, the battery cells 32 could alternatively be grouped together into two or more individual battery arrays/modules. The total number of battery cells 32 included as part of the battery system 22 is not intended to limit this disclosure.

In an embodiment, the battery cells 32 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The bus bar module 34 may be arranged to extend in span across top surfaces 36 (best shown in FIG. 3) of the battery cells 32. However, other configurations are also contemplated within the scope of this disclosure.

The bus bar module 34 may be a multi-layered assembly that consolidates subcomponents and simplifies cell-to-cell bussing and sense lead wiring routing of the battery system 22. In some implementations, the bus bar module 34 may eliminate the need for array-to-array interconnects. The size of the bus bar module 34 is scalable to address various manufacturing and packaging requirements of the traction battery pack 18.

The bus bar module 34 may include a base layer 38, a mid-layer 40, and a top layer 42. The base layer 38, the mid-layer 40, and the top layer 42 may be connected together to establish a unitary structure of the bus bar module 34. In an embodiment, the base layer 38, the mid-layer 40, and the top layer 42 are adhered together, such as using an adhesive or double-sided tape, for example.

Each of the base layer 38, the mid-layer 40, and the top layer 42 may be made out of a flat sheet of plastic. In an embodiment, the base layer 38, the mid-layer 40, and the top layer 42 are constructed of polypropylene or polyethylene. However, other materials are contemplated within the scope of this disclosure.

The base layer 38 may be received directly against the top surfaces 36 of the battery cells 32 and functions as a protective layer for protecting the battery cells 32 and isolating the battery cells 32 from bus bars 44 of the bus bar module 34. The base layer 38 may include a plurality of openings 50 formed therethrough. Each opening 50 may be sized and shaped to receive a terminal 46 of one of the battery cells 32. The base layer 38 therefore aids in locating the bus bar module 34 relative to the terminals 46 of the battery cells 32.

The mid-layer 40 may be sandwiched between the base layer 38 and the top layer 42 and may be configured for retaining the plurality of bus bars 44 of the bus bar module 34. The bus bar module 34 may position the bus bars 44 directly over top of the terminals 46 of the battery cells 32. The bus bar module 34 therefore locates the bus bars 44 at the proper position for securing (e.g., welding) the bus bars 44 to the terminals 46 for electrically connecting the battery cells 32. Each bus bar 44 may electrically connect a pair of terminals 46 of adjacent battery cells 32. The total number of bus bars 44 provided by the bus bar module 34 may vary and could depend on the number of battery cells 32 provided within the battery system 22, among various other factors. The bus bar module 34 is therefore not limited to the specific configuration shown in FIGS. 2 and 3.

The bus bars 44 may be stamped, relatively thin strips of metal that are configured to conduct the power stored by the battery cells 32. Example bus bar materials include copper, brass, or aluminum, although other conductive materials may also be suitable.

The mid-layer 40 may include a plurality of pockets 48, which are essentially voids formed in the mid-layer 40. Each pocket 48 may be sized and shaped to receive one of the bus bars 44. The pockets 48 may constrain movement of the bus bars 44 along two axes, e.g., an X-axis and a Y-axis. The bus bars 44 may be further constrained from the bottom by the base layer 38 and from the top by the top layer 42 along a third axis, e.g., a Z-axis. In an embodiment, the Z-axis is a vertical axis that extends in the direction of the vehicle height in an ordinary orientation of the electrified vehicle 10.

The bus bars 44 may be free floating between the mid-layer 40 and the top layer 42. The bus bars 44 are therefore permitted to move independently of the sublayers of the bus bar module 34 during pressing and welding operations.

The top layer 42 may be positioned on an opposite side of the mid-layer 40 form the base layer 38. The top layer 42 is configured to constrain the bus bars 44 along the Z-axis. The top layer 42 may further isolate the bus bars 44 from contact with the enclosure cover 26.

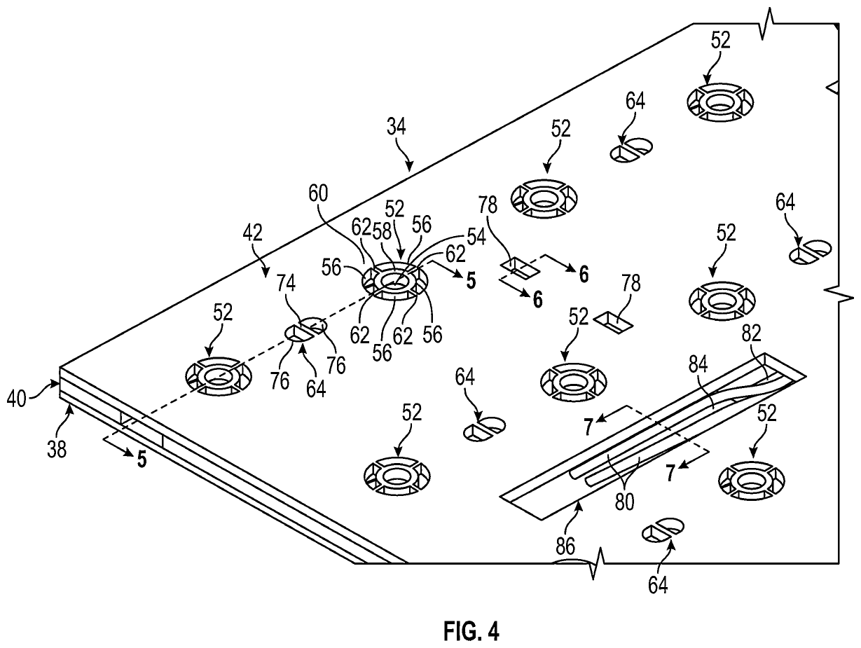

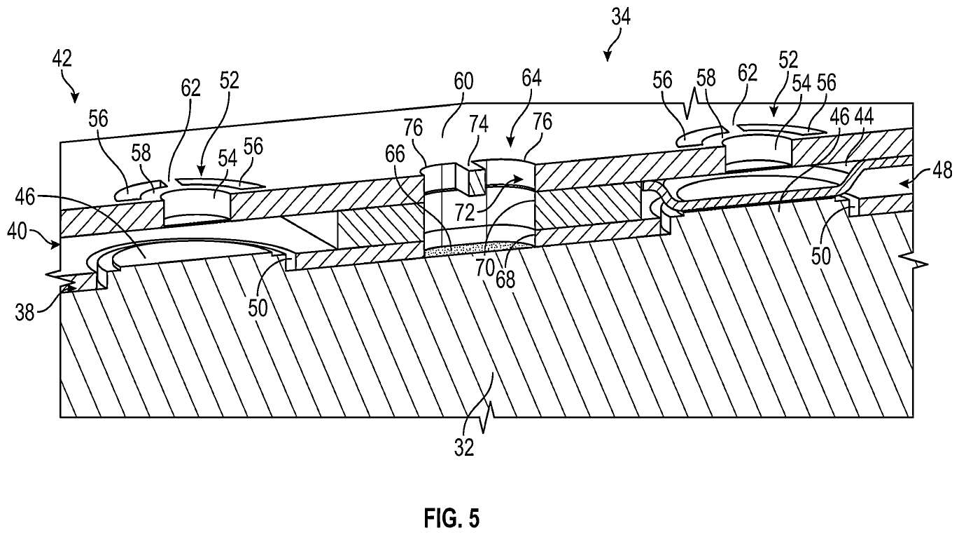

The base layer 38, the mid-layer 40, and the top layer 42 may cooperate to establish additional functionality of the bus bar module 34. For example, referring to FIGS. 4 and 5, the top layer 42 of the bus bar module 34 may include a plurality of welding access points 52. Each welding access point 52 may be formed in the top layer 42 and may be located at a position that is received over top of and in direct alignment with one of the bus bars 44, one of the terminals 46, and one of the openings 50 of the base layer 38.

Each welding access point 52 may include a central access port 54 and a plurality of peripheral access ports 56 that may be arranged to circumscribe the central access port 54. The central access port 54 may be formed through a ring 58 of the top layer 42. The ring 58 may be connected to a main body 60 of the top layer 42 by two or more struts 62. The struts 62 may be arranged to separate the peripheral access ports 56 from one another.

The central access port 54 and each of the peripheral access ports 56 are formed through the top layer 42 and therefore provide partial access to the bus bars 44. The ports 54, 56 are large enough to receive tooling for facilitating bus bar 44 pressing and welding operations but small enough to prevent finger access to the bus bars 44. The welding access points 52, as facilitated by the arrangement and configuration of the central access port 54 and the peripheral access ports 56, therefore provide “finger-proof” features for preventing inadvertent exposure to high voltage areas of the battery system 22.

The bus bar module 34 may further provide a plurality of vent ports 64. Each vent port 64 may be arranged over top of and in direct alignment with a vent system 66 of one of the battery cells 32 of the battery cell grouping. The vent system 66 is configured to expel battery vent byproducts, such as gases or other byproducts, from the battery cells 32 during certain battery venting events.

The vent ports 64 may be established by openings formed in each of the base layer 38, the mid-layer 40, and the top layer 42. For example, each vent port 64 may be established by a first opening 68 formed through the base layer 38, a second opening 70 formed through the mid-layer 40, and a third opening 72 formed through the top layer 42. The first opening 68, the second opening 70, and the third opening 72 may align with one another to form the vent port 64.

The third opening 72 of the top layer 42 may be bifurcated by a strut 74 to form a pair of sub-openings 76. The sub-openings 76 may be semicircle shaped, although other shapes are also possible. The struts 74 may be arranged to prevent finger access through the vent ports 64 to the underlying battery cells 32 of the battery system 22. Each vent port 64 therefore provides “finger-proof” features for preventing inadvertent exposure to high voltage areas of the battery system 22.

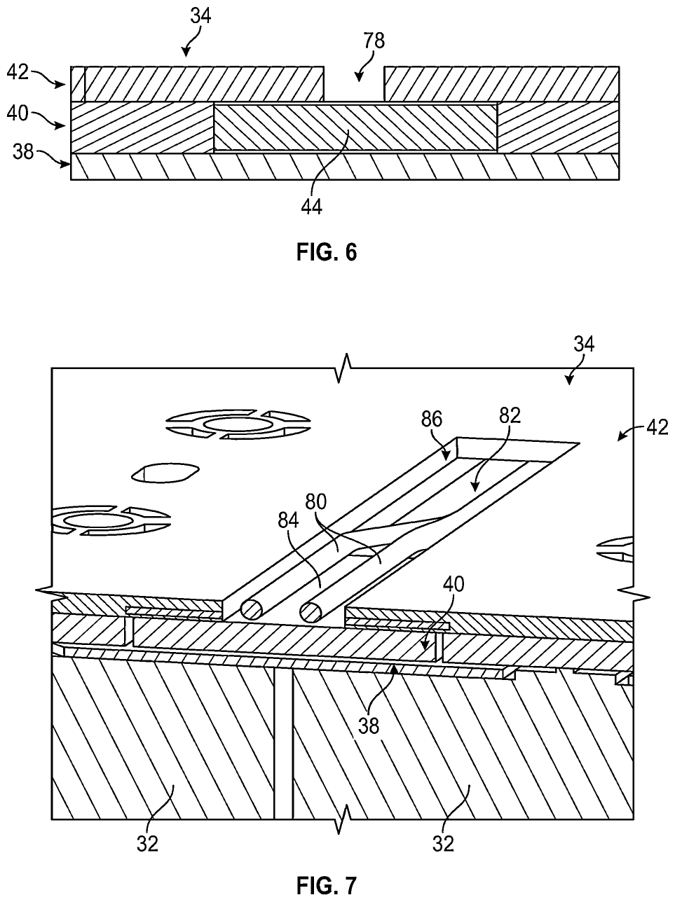

Referring now to FIGS. 4 and 6, the bus bar module 34 may further provide a plurality of sense lead testing access ports 78. The sense lead testing access ports 78 may be formed through the top layer 42 for providing tooling access to one or more sense lead wires 80 and/or the bus bars 44 for performing electrical tests to ensure proper battery cell 32 connections.

Referring now to FIGS. 4, 7, and 8, the bus bar module 34 may further provide integrated features for routing and retaining sense lead wires 80 of the bus bar module 34. The sense lead wires 80 may be configured to deliver voltage and other battery information concerning the battery cells 32 to a control module, such as a battery energy control module (BECM), for example.

The mid-layer 40 of the bus bar module 34 may include a plurality of wire pockets 82 for accommodating the sense lead wires 80. The wire pockets 82 may be formed through the mid-layer 40 and may be disposed between adjacent sections 85 that provide the pockets 48 for receiving the bus bars 44. The wire pockets 82 may be separated from one another by beams 84 that connect between the sections 85. The sense lead wires 80 may be accessed through slots 86 formed in the top layer 42.

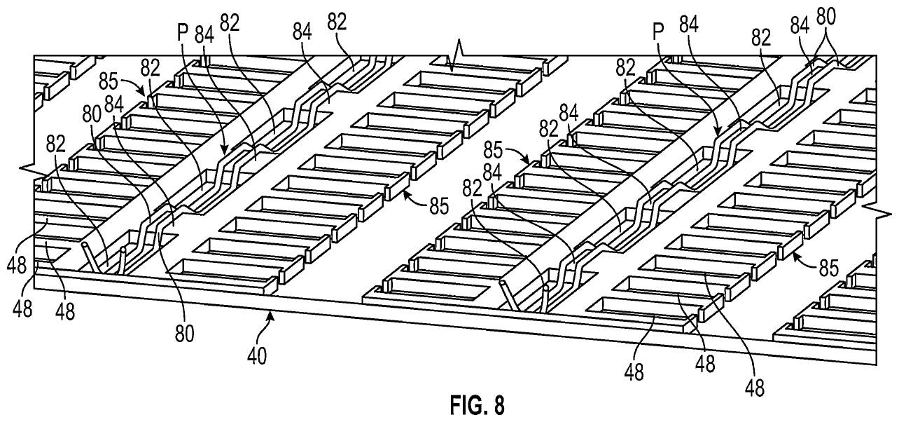

The sense lead wires 80 may be arranged in a weaving pattern P (see FIG. 8) relative to the mid-layer 40. The weaving pattern P may extend in and out of the wires pockets 82 and over the beams 84 for routing the sense lead wires 80 within the bus bar module 34. The sense lead wires 80 may be supported from underneath by the base layer 38.

The exemplary bus bar modules of this disclosure provide a multi-layer design that consolidates subcomponents and simplifies cell-to-cell bussing and sense lead wiring routing, especially for large format battery cell groupings. The bus bar modules are scalable for use with battery systems of all sizes and design requirements. The proposed bus bar modules may further eliminate the need for providing array-to-array bussing interconnects.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a grouping of battery cells; and
a bus bar module arranged to electrically connect the grouping of battery cells, wherein the bus bar module comprises:
a base layer positioned in contact with the grouping of battery cells;
a mid-layer configured to retain a plurality of bus bars along a first axis and a second axis; and
a top layer configured to retain the plurality of bus bars along a third axis.

2. The traction battery pack as recited in claim 1, wherein the first axis is an X-axis, the second axis is a Y-axis, and the third axis is a Z-axis.

3. The traction battery pack as recited in claim 1, wherein the mid-layer is sandwiched between the base layer and the top layer.

4. The traction battery pack as recited in claim 1, wherein the plurality of bus bars are isolated from the grouping of battery cells by the base layer.

5. The traction battery pack as recited in claim 1, wherein the bus bar module includes a welding access point formed in the top layer and located at a position that is received over top of and in direct alignment with a bus bar of the plurality of bus bars.

6. The traction battery pack as recited in claim 5, wherein the welding access point includes a central access port and a plurality of peripheral access ports arranged to circumscribe the central access port.

7. The traction battery pack as recited in claim 6, wherein the central access port is formed through a ring of the top layer, and further wherein the ring is connected to a main body of the top layer by a plurality of struts.

8. The traction battery pack as recited in claim 1, wherein the bus bar module includes a vent port arranged over top of and in direct alignment with a vent system of a battery cell of the grouping of battery cells.

9. The traction battery pack as recited in claim 8, wherein a first opening of the base layer, a second opening of the mid-layer, and a third opening of the top layer align with one another to establish the vent port.

10. The traction battery pack as recited in claim 9, wherein the third opening is bifurcated by a strut to form a pair of sub-openings in the top layer.

11. The traction battery pack as recited in claim 1, wherein the bus bar module includes a sense lead testing access port formed through the top layer.

12. The traction battery pack as recited in claim 1, wherein a sense lead wire of the bus bar module is arranged in a weaving pattern relative to the mid-layer.

13. The traction battery pack as recited in claim 12, wherein the weaving pattern extends in and out of a wire pocket and over a beam of the mid-layer.

14. A traction battery pack, comprising:
a grouping of battery cells; and
a bus bar module arranged to electrically connect the grouping of battery cells, wherein the bus bar module comprises:
a base layer;
a top layer;
a mid-layer sandwiched between the base layer and the top layer; and
a bus bar movably arranged between the mid-layer and the top layer.

15. The traction battery pack as recited in claim 14, wherein the top layer includes a welding access point located over the bus bar, and further wherein the bus bar is located over a terminal of a battery cell of the grouping of battery cells.

16. The traction battery pack as recited in claim 15, wherein the welding access point includes a central access port and a plurality of peripheral access ports arranged to circumscribe the central access port.

17. The traction battery pack as recited in claim 14, wherein the bus bar module includes a vent port arranged over a vent system of a battery cell of the grouping of battery cells.

18. The traction battery pack as recited in claim 17, wherein a first opening of the base layer, a second opening of the mid-layer, and a third opening of the top layer align with one another to establish the vent port.

19. The traction battery pack as recited in claim 14, wherein the bus bar module includes a sense lead wire arranged in a weaving pattern relative to the mid-layer.

20. The traction battery pack as recited in claim 19, wherein the weaving pattern extends in and out of a wire pocket and over a beam of the mid-layer.
